(19) United States
(12) Patent Application Publication
(10) Pub. No.: US 2008/0176594 A1
(43) Pub. Date: Jul. 24, 2008

(54) APPARATUS FOR CONTROLLING RADIATION POWER IN DUAL MODE MOBILE TERMINAL AND METHOD THEREOF

(75) Inventors: Young Kwang Song, Seoul (KR); Jong Goo Kim, Yongin-si (KR); Jae Kyong Choi, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/962,928

(22) Filed: Dec. 21, 2007

(30) Foreign Application Priority Data
Jan. 23, 2007 (KR) 2007-0007074

(51) Int. Cl. H04Q 7/20

(52) U.S. Cl. 455/522; 455/552.1

(57) ABSTRACT

An apparatus and a method for controlling radiation power of a mobile terminal in a call waiting state, having two antennas for supporting dual mode communication. The method for controlling radiation power of a mobile terminal includes receiving a call from a second communication network while communicating with a first communication network; holding a call of the first communication network in a call waiting state in response to input of an acceptance key for receiving the call from the second communication network; and communicating with the second communication network by reducing a call transmission power to the first communication network. Interference between the antennas may be reduced by reducing a call transmission power in a call waiting state.

### PRIORITY

This application claims priority under 35 U.S.C. §119(a) to an application filed in the Korean Intellectual Property Office on Jan. 23, 2007 and assigned Serial No. 2007-0007074, the contents of which are incorporated herein by reference.

### BACKGROUND OF THE INVENTION

1. Field of the Invention

The present invention generally relates to a mobile terminal, and more particularly, to an apparatus for controlling radiation power of a mobile terminal having two antennas to support dual mode communication, and a method thereof.

2. Description of the Prior Art

In recent wireless communication environments, data service technology may generally be classified into cellular mobile communication technology of a second and a half generation or third generation and wireless Local Area Network (LAN) technology. Cellular mobile communication technology includes Code Division Multiple Access 2000 1x Evolution Data Optimized (CDMA200 1xEVDO), General Packet Radio Services (GPRS), Universal Mobile Telecommunication Service (UMTS), and Global System for Mobile communication (GSM). Wireless LAN technology includes Institute of Electrical and Electronics Engineers (IEEE) 802.11.

A specific protocol must be used for a specific network system, and a multi mode mobile terminal has been developed to support a protocol of each network system.

Such a multi mode mobile terminal typically includes a modem and a Radio Frequency (RF) device corresponding to each network system and may use more than one antenna.

When a multi mode mobile terminal receives a call from a network while communicating with another network, the mobile terminal activates a call waiting mode. The call waiting mode is a state in which a mobile terminal holds a call from a network and performs communication with another network.

In a call waiting mode, a mobile terminal maintains connections with two different networks and transmits high-frequency radio signals through individual antennas. However, radiation power interference of the antennas occurs by receiving radio signals, and thereby deterioration of communication sensitivity and/or a communication circuit board is accelerated.

### SUMMARY OF THE INVENTION

The present invention substantially solves the above problems, and prevents deterioration of communication sensitivity and corresponding circuit boards in a mobile terminal having more than one antenna for supporting multi mode communication by reducing interference between the antennas.

According to an aspect of the present invention, a method is provided for controlling transmission power of a mobile terminal in a call waiting state, having two antennas for supporting two different communication networks, the method including receiving a call from a second communication network while communicating with a first communication network; holding a call of the first communication network in a waiting state responding to an acceptance key for receiving the call from the second communication network; and communicating with the second communication network by reducing a call transmission power to the first communication network.

Preferably, in communicating with the second communication unit, the call transmission power to the first communication network is reduced so radiation power at a first communication network antenna is not induced to a second communication network antenna and the call waiting state of the first communication network is maintained. Preferably, the call transmission power to the first communication network is reduced by 1 to 6 dB.

The method for controlling transmission power of a mobile terminal in a call waiting state may further include communicating with the second communication network by reducing a call transmission power to the second communication network.

Preferably, in communicating with the second communication network, the call transmission power to the second communication network is reduced so radiation power at the first communication network antenna is not induced to the second communication network antenna and the communication with the second communication network is maintained. Preferably, the call transmission power to the first communication network is reduced by 1 to 6 dB.

Preferably, one of the two different communication networks is a CDMA communication network and the other is a GSM communication network.

According to another aspect of the present invention, an apparatus is provided for controlling transmission power of a mobile terminal in a call waiting state, having two antennas for supporting two different communication networks, the apparatus including a first RF communication unit for receiving a call from a first communication network and transmitting a call to the first communication network; a second RF communication unit for receiving a call from a second communication network and transmitting a call to the second communication network; a transmission power regulator for adjusting call transmission powers of the first and second RF communication units; and a control unit for holding, when a call is received from the second communication network while communicating with the first communication network, the call of the second communication network in a waiting state, and for controlling the transmission power regulator to reduce a call transmission power of the first RF communication unit.

Preferably, the call transmission power of the first RF communication unit is reduced so radiation power of the first RF communication unit is not induced to the second RF communication unit and the call waiting state of the first communication network is maintained. Preferably, the control unit reduces the call transmission power of the first RF communication unit by 1 to 6 dB.

The control unit preferably controls the transmission power regulator so the call of the first communication network is held in a waiting state and the call transmission power of the second RF communication unit is reduced when a call is received from the second communication network while communicating with the first communication network.

Preferably, the call transmission power of the second RF communication unit is reduced so radiation power of the second RF communication unit is not induced to the first RF communication unit and the communication with the second communication network is maintained. Preferably, the control unit reduces the call transmission power of the second RF communication unit by 1 to 6 dB.

Preferably, the first and second RF communication units each include an antenna for receiving and transmitting a call and a power amplifier for amplifying a signal to be transmitted.

Preferably, the transmission power regulator reduces the call transmission power of the first RF communication unit and of the second RF communication unit by reducing the gain of the power amplifier of the first RF communication unit and of the second RF communication unit, respectively.

### BRIEF DESCRIPTION OF THE DRAWINGS

The above aspects, features and advantages of the present invention will become more apparent from the following description in conjunction with the accompanying drawings, in which:

FIG. 1 is a diagram showing a call waiting method for a mobile terminal using two different wireless communication networks according to the present invention;

FIG. 2 is a block diagram of a mobile terminal according to the present invention; and

FIGS. 3A, 3B and 3C are flow charts showing a method of controlling transmission power of a mobile terminal in a call waiting state according to the present invention.

### DETAILED DESCRIPTION OF THE PREFERRED EMBODIMENTS

Preferred embodiments of the present invention are described below with reference to the accompanying drawings. The same reference numbers are used throughout the drawings. Descriptions of constructions or processes known in the art may be omitted to avoid obscuring the subject matters of the present invention.

The descriptions provided below are examples only, and do not describe every possible instance of the invention. For example, wireless communication network systems hereafter described are a Code Division Multiple Access (CDMA) communication network system and a Global System for Mobile communication (GSM) communication network system. However, a communication hand-over method between different networks according to the present invention is not limited to the above network systems.

The present invention may utilize various communication network systems, such as GSM, General Packet Radio Services (GPRS), Enhanced Data GSM Environment (EDGE), Universal Mobile Telecommunication System (UMTS), CDMA, Wideband CDMA (WCDMA), Wireless Fidelity (Wi-Fi), 3rd Generation Partnership Project (3GPP), etc., and their extensions and modifications.

A mobile terminal supporting more than one communication network, such as a conventional mobile communication network, wireless Local Area Network (LAN), mobile Internet, etc., may be used as a multi mode terminal.

In the following descriptions of the present invention, examples of utilizing the above mobile terminals are illustrated. However, the present invention is not limited thereto and may utilize various information and communication devices, multimedia devices, and their applications, such as a digital broadcast terminal, Personal Digital Assistant (PDA), smart phone, International Mobile Telecommunication 2000 (IMT-2000) terminal, CDMA terminal, WCDMA terminal, GSM terminal, UMTS terminal, cellular phone, palm top computer, notebook computer, etc.

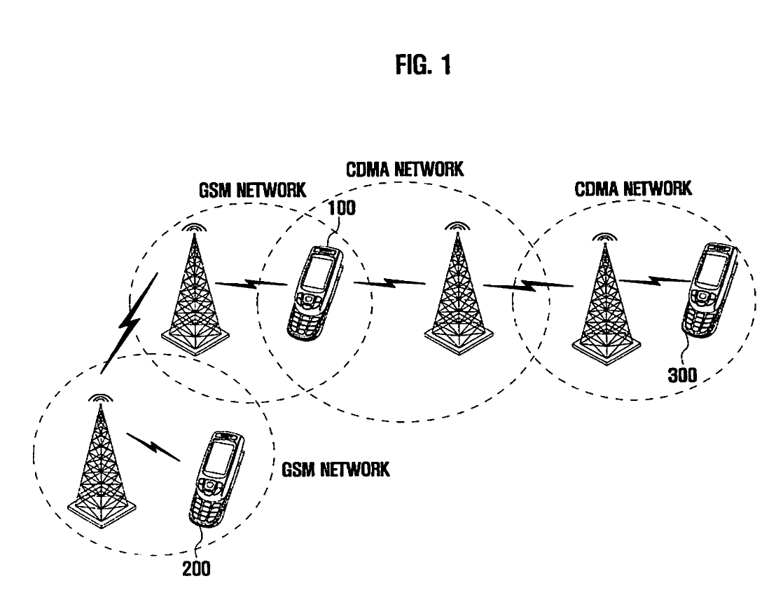

FIG. 1 shows a call waiting method for a mobile terminal 100 using two different wireless communication networks of a CDMA communication network system and a GSM communication network system according to the present invention.

In FIG. 1, a mobile terminal 100 according to the present invention is located in an area covered by a CDMA network and a GSM network and is in a standby state. A mobile terminal 200 is located in an area covered by a GSM network, and a mobile terminal 300 is located in an area covered by a CDMA network The mobile terminal 100 periodically measures a channel status using, for example, Received Signal Strength Indication (RSSI), Carrier to Interface plus Noise Ratio (CINR), and Quality of Service (QoS) by exchanging a signal of preamble and/or pilot channel with base stations of the CDMA network and the GSM networks. For this, power of communication device components, such as an antenna, Radio Frequency (RF) communication device, modem, etc., is switched on to use different networks. While communicating with one of the CDMA network and the GSM network, the mobile terminal 100 measures the channel state of the other network through a communication device component. A multi mode mobile terminal according to the present invention may include more than one antenna.

In FIG. 1, the first mobile terminal 100 is a mobile terminal according to the present invention; the second mobile terminal 200 is assumed to be a mobile terminal using a GSM network; and the third mobile terminal 300 is assumed to be a mobile terminal using a CDMA network.

When a call is received at the first mobile terminal 100 from a communication network while communicating with another communication network, the first mobile terminal 100 may perform a call waiting function.

For example, when the first mobile terminal 100 receives a call from the third mobile terminal 300 while communicating with the second mobile terminal 200, the first mobile terminal 100 holds the call from second mobile terminal 200. At this moment, the second mobile terminal 200 enters a state of transmitting a call waiting tone and the first mobile terminal 100 starts communication with the third mobile terminal 300.

The first mobile terminal 100 uses an antenna for call connections with the second mobile terminal 200 and another antenna for call connections with the third mobile terminal 300, and transmits signals individually through the two antennas.

In the present invention, one of the power levels of transmitting a signal may be reduced to prevent interference of signals between the two antennas. Accordingly, the intensity of a signal induced to an adjacent antenna may be reduced and deterioration of sensitivity of signal may be reduced.

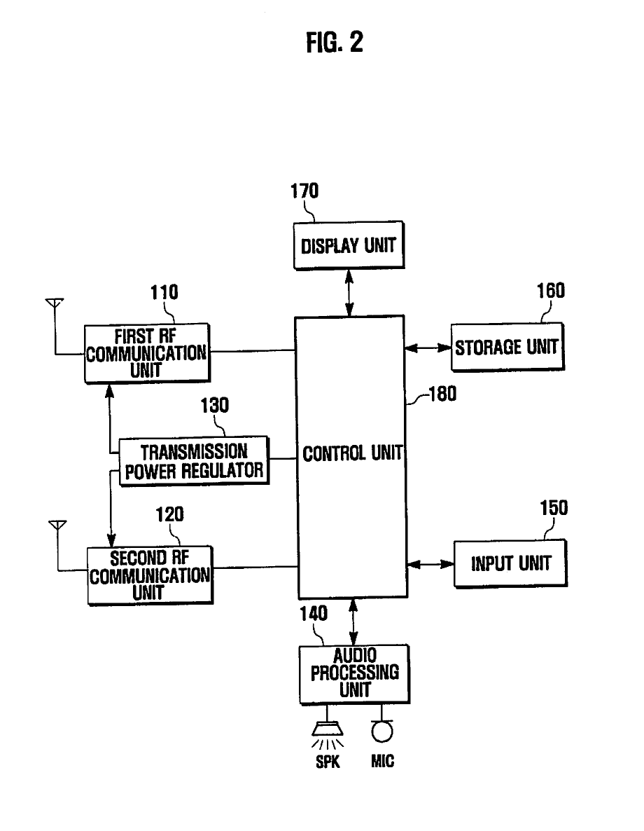

FIG. 2 shows a mobile terminal according to the present invention. The mobile terminal 100 includes a first RF communication unit 110, second RF communication unit 120, transmission power regulator 130, audio processing unit 140, input unit 150, storage unit 160, display unit 170, and control unit 180.

The first RF communication unit 110 and the second RF communication unit 120 perform wireless communication according to a protocol of each network. The first RF communication unit 110 is assumed to use a GSM network and the second RF communication unit 120 is assumed to use a CDMA network. For this, an RF transmitter for up-converting the frequency of a signal to be transmitted and amplifying the signal, and an RF receiver for low-noise amplifying a received signal and down-converting the frequency of the signal, may be included in each of the RF communication units 110 and 120.

Additionally, the first RF communication unit 110 and the second RF communication unit 120 may each include a data processing unit having a transmitter for encoding and modulating a signal to be transmitted and a receiver for demodulating and decoding a received signal. The data processing unit may further include a modulator/demodulator (modem) and a coder/decoder (codec). The codec includes a data codec for processing packet data and an audio codec for processing audio signals such as. a voice. The data processing unit may be configured independently from the first RF communication unit 110 and the second RF communication unit 120, and may be included in the control unit 180.

The first RF communication unit 110 and the second RF communication unit 120 include a power amplifier (not shown) for amplifying a signal received from the modem. When the first mobile terminal 100 performs a call waiting function, one of the first RF communication unit 110 and the second RF communication unit 120 transmits a signal by reducing an amplifying ratio of the signal. Hereinafter, ‘reducing an amplifying ratio of a signal’ is expressed as ‘reduction of call transmission power’.

The power amplifier increases the call transmission power of a signal by increasing the gain of the amplifier and outputs high current, and may thereby output a high decibel power. The power amplifier preferably uses a plurality of transistors to output the high dB power.

The first RF communication unit 110 and the second RF communication unit 120 may each include a duplexer (not shown) and a matching component (not shown) having an antenna at its end. The duplexer operates as a band-pass filter for processing the frequency of a signal received or to be transmitted and the matching component is a circuit for matching the impedance of transmission power. Each antenna radiates a signal amplified by the power amplifier to the air.

The transmission power regulator 130 preferably reduces a call transmission power of the first RF communication unit 110 or the second RF communication unit 120 by reducing the gain of the power amplifier according to the control of the control unit 180.

The audio processing unit 140 replays an audio signal output by the control 180 through a speaker SPK, and outputs a signal input through a microphone MIC, a voice, to the control unit 180 by using a converter.

The input unit 150 includes a plurality of alphanumeric keys and function keys for inputting characters and for setting various functions. The input unit 150 outputs a key input by related to a key input by a user for setting and controlling of mobile terminal functions to the control unit 180.

The storage unit 160 stores programs for operation of the mobile terminal 100, downloaded contents, and user data. The storage unit 160 may be configured with a program area and a data area. The program area stores an operating system of the mobile terminal 100 and application programs for managing character messages. The data area stores data generated during usage of the mobile terminal 100.

The display unit 170 outputs screen data received from the control unit 180. The display unit 170 provides visual information to a user, such as menus of the mobile terminal 100, user input data, and function settings. The display unit 170 is preferably formed with a Liquid Crystal Display (LCD), and may further include a controller for the LCD memory for storing moving picture files, and LCD panel.

The control unit 180 controls general operation of the mobile terminal 100 and signal flows between internal units of the mobile terminal 100, such as a transmission power regulator 130, audio processing unit 140, input unit 150, storage unit 160, display unit 170, etc. When a call is received while communicating using the first RF communication unit 10 or the second RF communication unit 120, the control unit 180 controls the transmission power regulator 130 to reduce a call transmission power of the first RF communication unit 110 or the second RF communication unit 120.

A method of performing a call waiting function in a mobile terminal is now described.

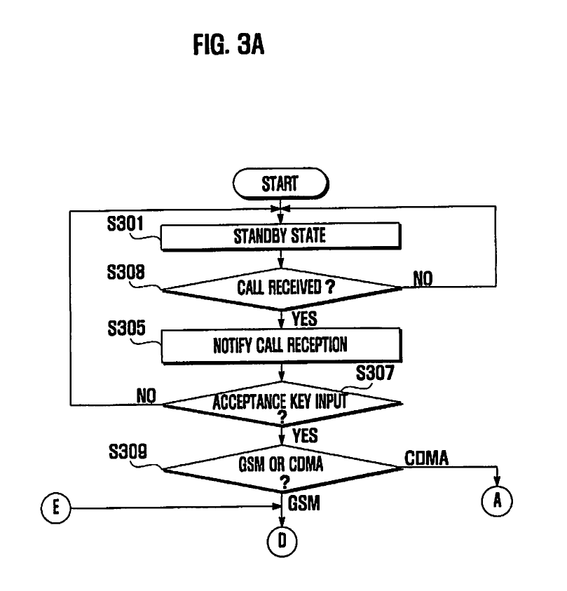

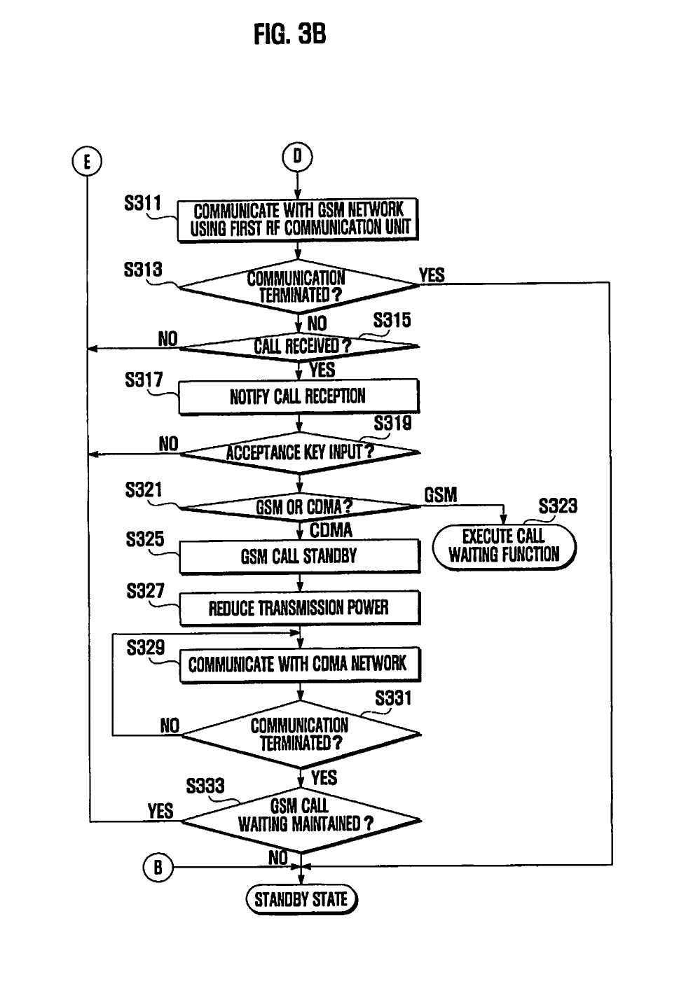

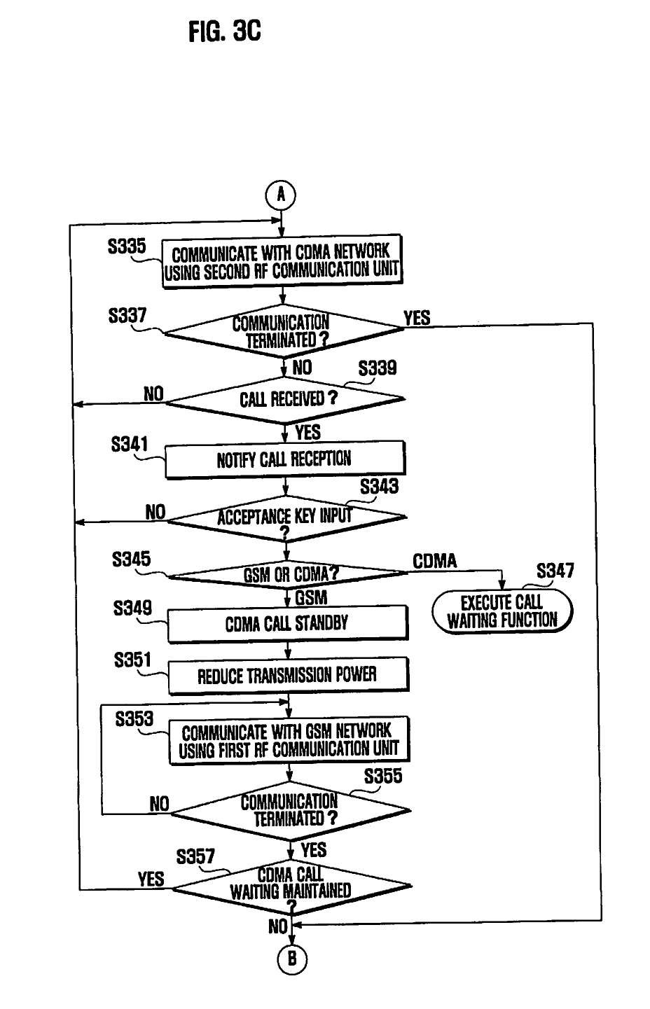

FIGS. 3A-3C show a method of controlling transmission power of a mobile terminal in a call waiting state according to the present invention.

The first RF communication unit 110 is assumed to be a communication unit for a GSM network and the second RF communication unit 120 is assumed to be a communication unit for a CDMA network. The second mobile terminal 200 is assumed to be a mobile terminal using a GSM network and the third mobile terminal 300 is assumed to be a mobile terminal using a CDMA network. The mobile terminal 100 according to the present invention may have a telephone number for the GSM network and another telephone number for the CDMA network.

Referring to FIG. 3A, the control unit 180 of the mobile terminal 100 is initially in a standby state in step S301. In the standby state, the mobile terminal 100 periodically measures a channel status using, for example, RSSI, CINR, and QoS by exchanging a signal of preamble and/or pilot channel with base stations of the CDMA network and the GSM network.

When a call is received in a standby state, the control unit 180 detects the call in step S303 and notifies reception of the call in step S305. The control unit 180 outputs communication information, such as a Caller Identification (CID), to the display unit 170. The control unit 180 controls the audio processing unit 140 to generate a ring tone. In a vibration mode, the control unit 180 controls to generate vibration instead of the ring tone. At this moment, a user determines, referring to the displayed communication information, whether to receive the call, and may input an acceptance key. The control unit 180 detects input of the acceptance key in step S307 and determines the type of the network to be connected in step S309.

Referring to FIG. 3B, when a call is received from a GSM network, the control unit 180 controls the first RF communication unit 110 to communicate with the second mobile terminal 200 through the GSM network in step S311. In this step, the second RF communication unit 120 may periodically check a channel status of the CDMA network.

While communicating with the second mobile terminal 200, the control unit 180 identifies whether the communication with the second mobile terminal 200 is terminated in step S313. When the communication with the second mobile terminal is terminated, the process returns to a standby state. When the communication with the second mobile terminal is not terminated, the control unit 180 identifies whether a new call is received in step S315. If a new call is not received, the process returns to step S311 and the first mobile terminal 100 continues to communicate with the second mobile terminal 200.

When the control unit 180 identifies that a new call is received at step S315, the control unit 180 notifies reception of the call in step S317. The control unit 180 outputs communication information, such as a CID, to the display unit 170. The control unit 180 controls the audio processing unit 140 to generate a ring tone. In a vibration mode, the control unit 180 controls to generate vibration instead of the ring tone. At this moment, the user determines, referring to the displayed communication information, whether to receive the call, and may input an acceptance key. The control unit 180 detects input of the acceptance key in step S319 and determines the type of the network to be connected in step S321.

When the call is received from a GSM network, the control unit 180 performs a call waiting function in step S323. When the call is received from a CDMA network, the control unit 180 controls the first RF communication unit 110 to hold the call from the GSM network in step S325. At this moment, the counterpart mobile terminal of the GSM network, namely, the second mobile terminal 200, generates a call waiting tone repeatedly. The control unit 180 controls the transmission power regulator 130 to reduce a call transmission power of the first RF communication unit 110 or the second RF communication unit 120 in step S327.

The reduction of a transmission power is preferably performed by reducing the gain of a power amplifier in the first RF communication unit 110 or in the second RF communication unit 120. That is, the control unit 180 controls radiation powers amplified individually by the power amplifiers of the first RF communication unit 110 and the second RF communication unit 120 so they do not interfere with each other at two antennas.

When reducing the call transmission power of the first RF communication unit 110, the radiation power at the antenna of the first RF communication unit 110 is reduced to a range in which the radiation power is not induced to the antenna of the second RF communication unit 120 and the call waiting status of the GSM network is maintained. The call transmission power is preferably reduced by 1 to 6 decibels (dB).

When reducing the call transmission power of the second RF communication unit 120, the radiation power at the antenna of the second RF communication unit 120 is reduced to a range in which the radiation power is not induced to the antenna of the first RF communication unit 110 and the communication through the CDMA network is maintained. The call transmission power is preferably reduced by 1 to 6 dB.

The control unit 180 performs communication with the third mobile terminal 300 by controlling the second RF communication unit 120 in a state that a call transmission power is reduced in step S329. While communicating with the third mobile terminal 300, the second mobile terminal 200 generates a call waiting tone repeatedly.

The control unit 180 identifies whether the communication with the third mobile terminal 300 is terminated in step S331. When the communication is not terminated, the control unit 180 returns to step S329 and continues the communication with the third mobile terminal 300 through the second RF communication unit 120. When the communication with the third mobile terminal 300 is terminated, the control unit 180 identifies whether the call from the GSM network is still waiting in step S333.

When the call from the GSM network is still waiting, the process returns to step S311 and the control unit 180 restarts the communication with the waiting second mobile terminal 200 through the first RF communication unit 110. When the call from the GSM network is not still waiting, that is, it is identified to be terminated, the control unit 180 returns to a standby state.

Referring to FIG. 3C, when a call is received from a CDMA network at step S309 in FIG. 3A, the control unit 180 controls the second RF communication unit 120 to communicate with the third mobile terminal 300 through the CDMA network in step S335. In this step, the first RF communication unit 120 may periodically check a channel status of the GSM network.

While communicating with the third mobile terminal 300, the control unit 180 identifies whether the communication with the third mobile terminal 300 is terminated in step S337. When the communication with the third mobile terminal 300 is terminated, the process returns to a standby state. When the communication with the third mobile terminal 300 is not terminated, the control unit 180 identifies whether a new call is received in step S339. When a new call is not received, the process returns to step S335 and the first mobile terminal 100 continues to communicate with the third mobile terminal 300.

When the control unit 180 identifies that a new call is received at step S339, the control unit 180 notifies reception of the call in step S341. The control unit 180 outputs communication information, such as a CID, to the display unit 170. The control unit 180 controls the audio processing unit 140 to generate a ring tone. In a vibration mode, the control unit 180 controls to generate vibration instead of the ring tone. At this moment, the user determines, referring to the displayed communication information, whether to receive the call, and may input an acceptance key. The control unit 180 detects input of the acceptance key in step S343 and determines the type of the network to be connected in step S345.

When the call is received from a CDMA network, the control unit 180 performs a call waiting function in step S347. When the call is received from a GSM network, the control unit 180 controls the second RF communication unit 120 to hold the call from the CDMA network in step S349. At this moment, the counterpart mobile terminal of the CDMA network, namely, the third mobile terminal 300, generates a call waiting tone repeatedly. The control unit 180 controls the transmission power regulator 130 to reduce a call transmission power of the first RF communication unit 110 or the second RF communication unit 120 in step S351.

The reduction of a transmission power is preferably performed by reducing the gain of a power amplifier in the first RF communication unit 110 or in the second RF communication unit 120. That is, the control unit 180 controls radiation powers amplified individually by the power amplifiers of the first RF communication unit 110 and the second RF communication unit 120 so they do not interfere with each other at two antennas.

When reducing the call transmission power of the second RF communication unit 120, the radiation power at the antenna of the second RF communication unit 120 is reduced to a range in which the radiation power is not induced to the antenna of the first RF communication unit 110 and the call waiting status of the CDMA network is maintained. The call transmission power is preferably reduced by 1 to 6 dB.

When reducing the call transmission power of the first RF communication unit 110, the radiation power at the antenna of the first RF communication unit 110 is reduced to a range in which the radiation power is not induced to the antenna of the second RF communication unit 120 and the communication through the GSM network is maintained. The call transmission power is preferably reduced by 1 to 6 dB.

The control unit 180 performs communication with the second mobile terminal 200 by controlling the first RF communication unit 110 in a state that a call transmission power is reduced in step S353. While communicating with the second mobile terminal 200, the third mobile terminal 300 generates a call waiting tone repeatedly.

The control unit 180 identifies whether the communication with the second mobile terminal 200 is terminated in step S355. When the communication is not terminated, the control unit 180 returns to step S353 and continues the communication with the second mobile terminal 200 through the first RF communication unit 110. When the communication with the second mobile terminal 200 is terminated, the control unit 180 identifies whether the call from the CDMA network is still waiting in step S357.

When the call from the CDMA network is still waiting, the process returns to step S335 and the control unit 180 restarts the communication with the waiting third mobile terminal 300 through the second RF communication unit 120. When the call from the CDMA network is not still waiting at step S357, that is, it is identified to be terminated, the control unit 180 returns to a standby state, as shown in FIG. 3A.

As described above, the present invention reduces interference between two antennas by reducing a call transmission power in a call waiting state. Accordingly, the present invention provides an advantage of reducing deterioration of communication sensitivity and corresponding circuit boards in a mobile terminal due to interference of radiation powers.

Although preferred embodiments of the present invention have been described above, it should be understood that many variations and modifications of the basic inventive concept herein described, which may appear to those skilled in the art, will still fall within the spirit and scope of the present invention as defined in the appended claims.

For example, a method of performing a call waiting function has been described referring to a GSM network and a CDMA network, however this method may also be applied to any mobile terminal or any system providing a multi mode function and having more than one antenna.

What is claimed is:

1. A method for controlling transmission power of a mobile terminal in a call waiting state, having two antennas for supporting two different communication networks, the method comprising:
receiving a call from a second communication network while communicating with a first communication network;
holding a call of the first communication network in a call waiting state in response to input of an acceptance key for receiving the call from the second communication network; and
communicating with the second communication network by reducing call transmission power to the first communication network.

2. The method of claim 1, wherein, in communicating with the second communication network, the call transmission power to the first communication network is reduced so radiation power at a first communication network antenna is not induced to a second communication network antenna and the call waiting state of the first communication network is maintained.

3. The method of claim 2, wherein the call transmission power to the first communication network is reduced by 1 to 6 decibels.

4. The method of claim 1, further comprising communicating with the second communication network by reducing the call transmission power to the second communication network.

5. The method of claim 4, wherein, in communicating with the second communication network, the call transmission power to the second communication network is reduced so radiation power at the first communication network antenna is not induced to the second communication network antenna and the communication with the second communication network is maintained.

6. The method of claim 5, wherein the call transmission power to the first communication network is reduced by 1 to 6 decibels.

7. The method of claim 1, wherein one of the two different communication networks is a Code Division Multiple Access (CDMA) communication network and the other is a Global System for Mobile communications (GSM) communication network.

8. An apparatus for controlling transmission power of a mobile terminal in a call waiting state, having two antennas for supporting two different communication networks, the apparatus comprising:
a first Radio Frequency (RF) communication unit for receiving a call from a first communication network and transmitting a call to the first communication network;
a second RF communication unit for receiving a call from a second communication network and transmitting a call to the second communication network;
a transmission power regulator for adjusting call transmission powers of the first and second RF communication units; and
a control unit for holding, when a call is received from the second communication network while communicating with the first communication network, the call of the first communication network in a waiting state, and for controlling the transmission power regulator to reduce the call transmission power to the first RF communication unit.

9. The apparatus of claim 8, wherein the call transmission power to the first RF communication unit is reduced so radiation power of the first RF communication unit is not induced to the second RF communication unit and the call waiting state of the first communication network is maintained.

10. The apparatus of claim 9, wherein the control unit reduces the call transmission power of the first RF communication unit by 1 to 6 decibels.

11. The apparatus of claim 10, wherein the control unit controls the transmission power regulator so a call of the first communication network is held in a waiting state and the call transmission power of the second RF communication unit is reduced when a call is received from the second communication network while communicating with the first communication network.

12. The apparatus of claim 11, wherein the call transmission power of the second RF communication unit is reduced so radiation power of the second RF communication unit is not induced to the first RF communication unit and the communication with the second communication network is maintained.

13. The apparatus of claim 12, wherein the control unit reduces the call transmission power of the second RF communication unit by 1 to 6 decibels.

14. The apparatus of claim 8, wherein the first and second RF communication units each include an antenna for receiving and transmitting a call and a power amplifier for amplifying a signal to be transmitted.

15. The apparatus of claim 14, wherein the transmission power regulator reduces the call transmission power of the first RF communication unit and of the second RF communication unit by reducing the gain of the power amplifier of the first RF communication unit and of the second RF communication unit, respectively.
